(19) United States
(12) Patent Application Publication
(10) Pub. No.: US 2025/0362440 A1
(43) Pub. Date: Nov. 27, 2025

(54) POLARIZATION INTERFERENCE ELEMENT AND FILTER

(71) Applicant: FUJIFILM Corporation, Tokyo (JP)

(72) Inventors: Yukito SAITOH, Kanagawa (JP); Yujiro YANAI, Kanagawa (JP); Kazuya HISANAGA, Kanagawa (JP)

(73) Assignee: FUJIFILM Corporation, Tokyo (JP)

(21) Appl. No.: 19/294,355

(22) Filed: Aug. 8, 2025

Related U.S. Application Data
(63) Continuation of application No. PCT/JP2024/008593, filed on Mar. 6, 2024.

(30) Foreign Application Priority Data
Mar. 8, 2023 (JP) 2023-035589
Jan. 26, 2024 (JP) 2024-010059

(51) Int. Cl. G02B 5/28; G02B 5/30

(52) U.S. Cl. CPC G02B 5/28; G02B 5/3025

(57) ABSTRACT

A polarization interference element that minimizes wavelength shift at maximum transmittance when light is incident at an oblique angle, particularly when used between two polarizers. The polarization interference element includes two or more retardation layer sets arranged in the thickness direction. Each set consists of a first retardation layer and a second retardation layer. The Nz factor for both the first and second retardation layers is independently between 0.3 and 0.7. The in-plane slow axes of the first and second retardation layers intersect, and the in-plane retardation of the first and second retardation layers are equal. The invention further encompasses a filter incorporating this polarization interference element.

### CROSS-REFERENCE TO RELATED APPLICATIONS

This application is a Continuation of PCT International Application No. PCT/JP2024/008593 filed on Mar. 6, 2024, which claims priority under 35 U.S.C. § 119(a) to Japanese Patent Application No. 2023-035589 filed on Mar. 8, 2023 and Japanese Patent Application No. 2024-010059 filed on Jan. 26, 2024. The above applications are hereby expressly incorporated by reference, in their entirety, into the present application.

### BACKGROUND OF THE INVENTION

### 1. Field of the Invention

The present invention relates to a polarization interference element and an optical filter.

### 2. Description of the Related Art

A band-pass filter that transmits light in a specific wavelength range and shields light in other wavelength ranges is used in various optical devices.

As the band-pass filter, a polarization interference filter using a dielectric multi-layer film, a filter having a polarizer and a birefringent crystal in combination, and the like are known.

In addition, a band-pass filter is also known, in which a birefringent plate (λ/2 plate) in which an angle formed between a direction of a transmission axis of a polarizer and a slow axis is +p, and a birefringent plate in which the angle is −p, the both plates having the same thickness, are alternately laminated between polarizers arranged in a crossed nicols state, as described in JP2004-101577A.

Furthermore, JP2004-101577A proposes, as an optical filter (band-pass filter) having a small number of components, an optical filter consisting of crystals and having a structure where two types of polarization regions having different crystals are periodically arranged, in which the principal axis of a refractive index ellipsoid cut parallel to an interface between the two different types of polarization regions differs between the two different types of polarization regions.

### SUMMARY OF THE INVENTION

In such a band-pass filter, there is a problem in that a so-called short-wavelength shift occurs, in which a wavelength at which the maximum transmittance is exhibited differs between light incident from the front (vertical direction) and light incident from an oblique direction.

An object of the present invention is to provide a polarization interference element in which a shift in wavelength at which the maximum transmittance is exhibited is unlikely to occur even in a case where light is incident from an oblique direction during use of the polarization interference element arranged between two polarizers. In addition, another object of the present invention is to provide a filter having the polarization interference element.

In order to accomplish the objects, the present invention has the following configurations.
[1] A polarization interference element including:
two or more retardation layer sets in a thickness direction, each set consisting of a first retardation layer and a second retardation layer,
in which an Nz factor of the first retardation layer and an Nz factor of the second retardation layer are each independently 0.3 to 0.7,
an in-plane slow axis of the first retardation layer and an in-plane slow axis of the second retardation layer intersect with each other, and
an in-plane retardation of the first retardation layer and an in-plane retardation of the second retardation layer are equal to each other.
[2] The polarization interference element according to [1],
in which the polarization interference element has three or more retardation layer sets in the thickness direction, and
two retardation layer sets A arranged at both ends in the thickness direction among the three or more retardation layer sets, and at least one retardation layer set B arranged between the retardation layer sets A among the three or more retardation layer sets satisfy the following requirement.
Requirement: An angle formed between an in-plane slow axis of the first retardation layer and an in-plane slow axis of the second retardation layer in the retardation layer set A is smaller than an angle formed between an in-plane slow axis of the first retardation layer and an in-plane slow axis of the second retardation layer in the retardation layer set B, and an in-plane retardation of the first retardation layer in the retardation layer set A is larger than an in-plane retardation of the first retardation layer in the retardation layer set B.
[3] A filter including:
the polarization interference element according to [1] or [2]; and two polarizers that sandwich the polarization interference element in a thickness direction.
[4] The filter according to [3],
in which the two polarizers are arranged such that transmission axes of the two polarizers are orthogonal to each other.
[5] The filter according to [3],
in which the two polarizers are arranged such that transmission axes of the two polarizers are parallel to each other.
[6] The filter according to any one of [3] to [5], further including:
a third retardation layer between at least one of the two polarizers and the polarization interference element,
in which an in-plane slow axis of the third retardation layer is parallel to an absorption axis of either of the two polarizers.

According to the present invention, it is possible to provide a polarization interference element in which a shift in wavelength at which the maximum transmittance is exhibited is unlikely to occur even in a case where light is incident from an oblique direction during use of the polarization interference element arranged between two polarizers. In addition, according to the present invention, it is possible to provide a filter having the polarization interference element.

### BRIEF DESCRIPTION OF THE DRAWINGS

FIG. 1 is a view conceptually showing an example of a filter having a polarization interference element of an embodiment of the present invention.

FIG. 2 is a graph for describing optical characteristics of the filter.

FIG. 3 is a graph for describing optical characteristics of the filter.

### DESCRIPTION OF THE PREFERRED EMBODIMENTS

Hereinafter, the present invention will be described in detail based on suitable embodiments shown in the accompanying drawings.

In the present specification, numerical ranges represented by “to” include numerical values before and after “to” as lower limit values and upper limit values.

In the present specification, Re and Rth each represent an in-plane retardation and a thickness-direction retardation at a wavelength λ, respectively. A wavelength in a case of measuring the measurement of each retardation is 550 nm unless otherwise specified.

In the present specification, Re and Rth are values measured at a wavelength λ in AxoScan OPMF-1 (manufactured by Axometrics, Inc.). By inputting an average refractive index ((nx+ny+nz)/3) and a film thickness (d (μm)) in AxoScan,in-plane slow axis direction (*)Re=R0(λ)Rth=((nx+ny)/2−nz)×dare calculated.

Furthermore, R0(2) is expressed in a numerical value calculated with AxoScan OPMF-1, but means Re.

In the present specification, the Nz factor is a value given by Nz=(nx−nz)/(nx−ny).

In the present specification, the Nz factor of a retardation film (or a phase difference film, which shall apply hereinafter) is a value measured at a wavelength λ using AxoScan OPMF-1 (manufactured by Axometrics, Inc.). A wavelength in a case of measuring the Nz factor is set to 550 nm unless otherwise specified.

For each of the above-described retardation and Nz factor, nx is a refractive index in a direction of an in-plane slow axis in which a refractive index is maximum in a plane of the retardation film, ny is a refractive index in an in-plane fast axis direction orthogonal to the in-plane slow axis in the plane of the retardation film, and nz is a refractive index in the thickness direction of the retardation film. Each of the refractive indices nx, ny, and nz is a refractive index at a wavelength of 550 nm unless otherwise specified.

In the present specification, the refractive indices, nx, ny, and nz are measured with an Abbe refractometer (NAR-4T, manufactured by Atago Co., Ltd.), using a sodium lamp (λ=589 nm) as a light source. In addition, in a case where a wavelength dependency is measured, it can be measured with a multi-wavelength Abbe refractometer DR-M2 (manufactured by Atago Co., Ltd.) in combination with an interference filter.

Moreover, the values mentioned in Polymer Handbook (JOHN WILEY & SONS, INC.) and the catalogues of various optical films can be used. The values of the average refractive indices of major optical films are exemplified below: cellulose acylate (1.48), cycloolefin polymer (1.52), polycarbonate (1.59), polymethyl methacrylate (1.49), and polystyrene (1.59).

In the present specification, “visible light” refers to light having a wavelength of 380 to 800 nm.

In the present specification, angles (for example, “90°”) and relationships regarding angles (for example, “parallel” and “perpendicular”) include a range of errors that are allowed in the technical field to which the present invention belongs. For example, the angle means an angle in a range of less than +5° of a rigorous angle, and the error from the rigorous angle is preferably 3° or less, and more preferably 1° or less.

In the present specification, the meaning of the term “the same”, “equal”, or the like includes a case where an error range is generally allowable in the technical field.

In the present specification, the “absorption axis” of a polarizer means a direction in which the absorbance is highest. The “transmission axis” means a direction in which an angle of 90° is formed with respect to the “absorption axis”.

In the present specification, the “in-plane slow axis” of the retardation layer and the retardation film means a direction in which the in-plane refractive index is maximum.

In addition, all of the drawings shown below are conceptual views for describing the present invention, and the positional relationship, size, thickness, shape, and the like of each constituent element are different from the actual ones.

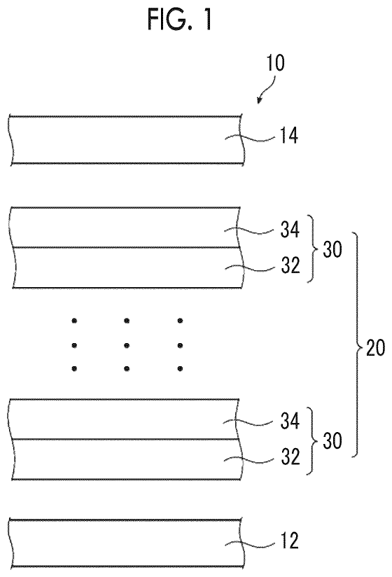

An example of a filter having a polarization interference element of the embodiment of the present invention is conceptually shown in FIG. 1. A filter 10 shown in FIG. 1 has a first polarizer 12, a second polarizer 14, and a polarization interference element 20.

Both the first polarizer 12 and the second polarizer 14 are polarizers (polarizing plates) that transmit linearly polarized light in a predetermined direction, and the first polarizer 12 and the second polarizer 14 are arranged in a crossed nicols state where transmission axes thereof are orthogonal to each other.

As will be described later, the polarization interference element 20 is an optical element that acts as a λ/2 retardation plate for light in a specific wavelength range and does not act as a retardation layer for the other light, and is arranged between the first polarizer 12 and the second polarizer.

In the filter 10 shown in the drawing, in a case where light is incident on the filter 10 from the outside of the first polarizer 12 in the thickness direction, first, only linearly polarized light in a predetermined direction is transmitted through the first polarizer 12. Since the polarization interference element 20 acts as a retardation layer for light in a specific wavelength range of the transmitted linearly polarized light, the polarization direction of the light is rotated by 90° while the light is transmitted through the polarization interference element 20, and the light is transmitted through the first polarizer 12 and the second polarizer 14 arranged in a crossed nicols state. In contrast, light having a wavelength other than the specific wavelength range in the linearly polarized light transmitted through the first polarizer 12 is not transmitted through the second polarizer 14 and is shielded by the second polarizer 14 since the polarization interference element 20 does not act as a retardation layer and the polarization direction of the light is not rotated by 90°.

The filter 10 shown in FIG. 1 has such a configuration, and thus functions as a band-pass filter (narrowband filter) that transmits light in a specific wavelength range and shields light in other wavelength ranges.

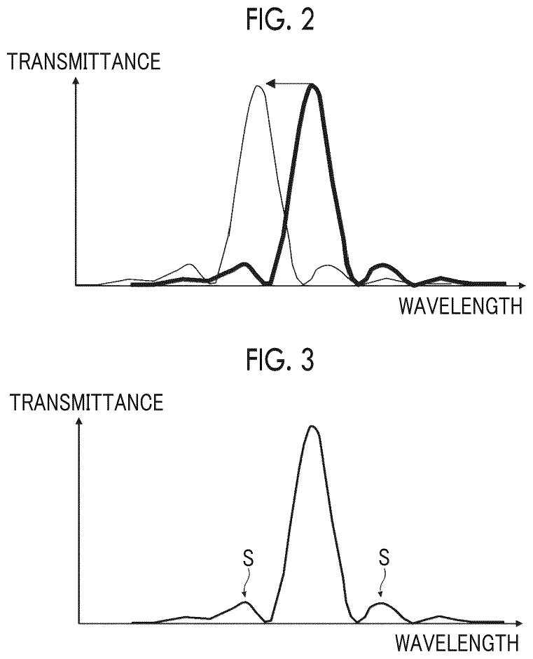

The optical characteristics of a general filter are conceptually shown in FIG. 2. As shown in FIG. 2, in the band-pass filter, in a case where light is incident on the filter from an oblique direction, a wavelength shift in which a transmission wavelength range moves to the shorter wavelength side occurs, as compared to a case where the light is incident on the filter from a normal direction (thickness direction).

In contrast, in a case where the polarization interference element of the embodiment of the present invention, which has two or more retardation layer sets, each consisting of the first retardation layer and the second retardation layer having an Nz factor of 0.3 to 0.7, in which the in-plane slow axes intersect with each other and the in-plane retardations Re's are equal to each other, is used while being arranged between two polarizers (for example, two polarizers arranged in a crossed nicols state), a wavelength shift (coloring) upon incidence of light on the filter from an oblique direction can be suppressed.

Hereinafter, the configuration and the like of the polarization interference element of the embodiment of the present invention will be described in more detail.

### Polarization Interference Element

The polarization interference element 20 of the embodiment of the present invention is a laminate in which two or more retardation layer sets 30, each consisting of a first retardation layer 32 and a second retardation layer 34, are laminated in the thickness direction.

Each of the retardation layer sets 30 included in the polarization interference element 20 consists of the first retardation layer 32 having an Nz factor of 0.3 to 0.7, and the second retardation layer 34 having an Nz factor of 0.3 to 0.7 and an in-plane retardation Re equal to an in-plane retardation Re of the first retardation layer 32.

In addition, in each of the retardation layer sets 30, the in-plane slow axis of the first retardation layer 32 and the in-plane slow axis of the second retardation layer 34 intersect with each other. Here, the expression “the in-plane slow axis of the first retardation layer and the in-plane slow axis of the second retardation layer intersect with each other” means that as viewed in the thickness direction (lamination direction) of the retardation layer set, the direction of the in-plane slow axis of the first retardation layer and the direction of the in-plane slow axis of the second retardation layer are not parallel to each other.

In the polarization interference element 20, two or more retardation layer sets 30 are laminated in the thickness direction. Accordingly, the total number of laminations of the first retardation layers 32 and the second retardation layers 34 included in the polarization interference element 20 is an even number.

Furthermore, the Nz factor, Re, and the in-plane slow axis direction (°) of each retardation layer in the polarization interference element can be measured using AxoScan manufactured by Axometrics, Inc.

In addition, the number of each of the first retardation layers, the second retardation layers, and the retardation layer sets included in the polarization interference element can be detected by measuring the in-plane slow axis along the lamination direction of the polarization interference element since the in-plane slow axis varies for each retardation layer.

As described above, the polarization interference element 20 has two or more retardation layer sets 30, each consisting of the first retardation layer 32 and the second retardation layer 34, in which the Nz factors are 0.3 to 0.7, the in-plane slow axes intersect with each other, and the in-plane retardations Re's are equal to each other. That is, the light that passes through the polarization interference element 20 is repeatedly influenced by a retardation layer having a slow axis in one in-plane direction and by a retardation layer having a slow axis in a direction different from the one in-plane direction.

Therefore, the polarization interference element 20 that acts as a λ/2 retardation plate for light in a specific wavelength range and does not act as a retardation plate, that is, does not feel the retardation can be formed by setting the in-plane retardations Re's of the first retardation layer 32 and the second retardation layer 34 depending on the wavelength range transmitted through the filter 10, and adjusting the direction of each of the in-plane slow axes of the first retardation layer 32 and the second retardation layer 34 depending on the total number of laminations of the first retardation layers 32 and the second retardation layers 34, in the polarization interference element 20.

### First Retardation Layer and Second Retardation Layer

The first retardation layer and the second retardation layer are not limited as long as the layers are layers having an Nz factor of 0.3 to 0.7 and an in-plane retardation Re which will be described below. Hereinafter, in a case where the first retardation layer and the second retardation layer are mentioned without distinction, the layers are also simply referred to as a “retardation layer”.

The Nz factor of the retardation layer is preferably 0.35 to 0.65, more preferably 0.4 to 0.6, and still more preferably 0.45 to 0.55 from the viewpoint that a shift in wavelength at which a maximum transmittance is exhibited even in a case where light is incident from an oblique direction during use of the polarization interference element arranged between two polarizers (for example, two polarizers arranged in a crossed nicols state).

The Nz factors of the retardation layers included in the polarization interference element may be the same as or different from each other as long as the Nz factors are within the range. It is preferable that the Nz factor of the first retardation layer and the Nz factor of the second retardation layer constituting the same retardation layer set are the same as each other.

In the polarization interference element of the embodiment of the present invention, Re of the first retardation layer and Re of the second retardation layer forming the same retardation layer set are equal to each other. Here, the expression, “Re of the first retardation layer and Re of the second retardation layer are equal to each other”, means that an absolute value of a difference between Re of the first retardation layer and Re of the second retardation layer is 10 nm or less. The absolute value of the difference between Re of the first retardation layer and Re of the second retardation layer is preferably 5 nm or less, and more preferably 3 nm or less.

The polarization interference element of the embodiment of the present invention acts as a λ/2 retardation plate only for light in a specific wavelength range. In response to this, Re of the retardation layer is appropriately set according to half the central wavelength (half-wavelength) of a wavelength range assumed to be transmitted through the filter, that is, a wavelength at which the polarization interference element is assumed to act as a λ/2 retardation plate.

For example, in a case where the wavelength at which the polarization interference element acts as a λ/2 retardation plate, that is, the central wavelength of the wavelength range transmitted through the filter is set to 550 nm, it is preferable that Re of the retardation layer is set to 275 nm. In this case, Re of the retardation layer may have an error of about ±10% with respect to the half-wavelength of the transmitted light of the filter.

In the polarization interference element, Re of the first retardation layer and Re of the second retardation layer forming the same retardation layer set are equal to each other, but Re of the retardation layers included in different retardation layer sets may be the same as or different from each other. It should be noted that in a case where the polarization interference element has two or more retardation layers which constitute different retardation layer sets and have different Re's (that is, in a case where the polarization interference element has two or more retardation layer sets having different Re values), it is preferable that an average value of Re's of all of the retardation layers included in the polarization interference element is set to approximately the half-wavelength of the transmitted light. Here, the “approximately half-wavelength of the transmitted light” refers to, for example, a range of about ±10% with respect to the half-wavelength of the transmitted light.

In a case where two or more retardation layer sets having different Re's are present in the polarization interference element as described above and the average value of Re's of all of the retardation layers included in the polarization interference element is approximately the half-wavelength of transmitted light, a detailed mechanism is unknown, but a side lobe described below can be reduced, which is thus preferable.

With regard to an angle formed between an in-plane slow axis of the first retardation layer 32 and an in-plane slow axis of the second retardation layer 34 constituting the retardation layer set 30 (hereinafter also referred to as an “angle θs”), an optimum angle at which the polarization interference element 20 acts as a λ/2 retardation plate is set by simulation depending on a central wavelength of a wavelength range assumed to be transmitted through the filter 10 and a total number N of laminations of the first retardation layers 32 and the second retardation layers 34.

In the simulation, a general optical simulation unit can be used, or calculation can be performed using LCD Master 1D (manufactured by SHINTECH Co., Ltd., Ver 9.8.0.0).

Here, according to the simulation by the present inventors, the optimum value of the angle θs formed between the in-plane slow axis of the first retardation layer 32 and the in-plane slow axis of the second retardation layer 34 with respect to the total number N of laminations of the first retardation layers 32 and the second retardation layers 34 is as follows.

In a case where the number N of laminations is 4 (two retardation layer sets), the optimum value of the angle θs is 22.5°.

In a case where the number N of laminations is 6 (three retardation layer sets), the optimum value of the angle θs is 15°.

In a case where the number N of laminations is 8 (four retardation layer sets), the optimum value of the angle θs is 11.2°.

In a case where the number N of laminations is 10 (five retardation layer sets), the optimum value of the angle θs is 9°.

In a case where the number of lamination N is 12 (six retardation layer sets), the optimum value of the angle θs is 7.5°.

In a case where the number N of laminations is 14 (seven retardation layer sets), the optimum value of the angle θs is 6.4°.

In a case where the number N of laminations is 16 (eight retardation layer sets), the optimum value of the angle θs is 5.6°.

The polarization interference element of the embodiment of the present invention has two or more retardation layer sets, and the angles θs's of the respective retardation layer sets may be the same as or different from each other. In a case where the polarization interference element has retardation layer sets in which the angles θs's are different from each other, it is preferable that the orientation of the in-plane slow axis of each retardation layer is set such that an average value of the angles θs's obtained by dividing a total value of the angles θs's of all of the retardation layer sets included in the polarization interference element by the number of the retardation layer sets included in the polarization interference element is an optimum angle at which the polarization interference element acts as a λ/2 retardation plate for light in a target wavelength range.

In addition, in a case where one retardation layer set is viewed in the thickness direction, a bisector of an angle θs formed between the in-plane slow axis of the first retardation layer and the in-plane slow axis of the second retardation layer is denoted by a line Lb. In a case where the polarization interference element is used while being arranged between two polarizers arranged in a crossed nicols state, it is preferable that the lines Lb of all of the retardation layer sets included in the polarization interference element are directed in the same direction as the polarization interference element is viewed in the thickness direction. Specifically, it is preferable that the directions (azimuth angles) of the lines Lb of all of the retardation layer sets included in the polarization interference element are in a range of within 10°, and it is more preferable that the directions (azimuth angles) of the lines Lb of all of the retardation layer sets included in the polarization interference element coincide (angle: ) 0°.

As described above, θs's of the retardation layer sets included in the polarization interference element may be the same as or different from each other, and Re's of the retardation layer may be the same as or different from each other between different retardation layer sets.

As an example of the configuration of the polarization interference element, there may be an aspect in which the polarization interference element has three or more retardation layer sets in a thickness direction (lamination direction), and two retardation layer sets A arranged at both ends in the thickness direction among the three or more retardation layer sets and at least one retardation layer set B arranged between the retardation layer sets A among the three or more retardation layer sets satisfy the following requirement A.

Requirement A: An angle θs formed between an in-plane slow axis of the first retardation layer and an in-plane slow axis of the second retardation layer in the retardation layer set A is smaller than an angle θs formed between an in-plane slow axis of the first retardation layer and an in-plane slow axis of the second retardation layer in the retardation layer set B, and Re of the first retardation layer (and Re of the second retardation layer) in the retardation layer set A is larger than Re of the first retardation layer (and Re of the second retardation layer) in the retardation layer set B.

More specific examples of the layer configuration include a layer configuration of a polarization interference element having eight retardation layers, that is, four retardation layer sets, in which in the first retardation layer set, Re of a first retardation layer (first layer) and a second retardation layer (second layer) is Re1, and θs of the first retardation layer set is θs1, in the second retardation layer set, Re of a first retardation layer (third layer) and a second retardation layer (fourth layer) is Re2 that is smaller than Re1, and θs of the second retardation layer set is θs2 that is larger than θs1, in the third retardation layer set, Re of a first retardation layer (fifth layer) and a second retardation layer (sixth layer) is Re2, and θs of the third retardation layer set is θs2, and in the fourth retardation layer set, Re of a first retardation layer (seventh layer) and a second retardation layer (eighth layer) is Re1, and θs of the fourth retardation layer set is θs1.

The optical characteristics of a general filter are conceptually shown in FIG. 3. In the band-pass filter, as indicated by an arrow S in FIG. 3, a transmission wavelength region called a side lobe is generated at a position of a wavelength shorter than a target transmission wavelength region and a position of a wavelength longer than the target transmission wavelength region.

In contrast, as described above, by increasing Re of the retardation layer of the retardation layer set A arranged on both end sides of the thickness direction larger, and decreasing θs of the retardation layer set A, respectively, than those of the retardation layer set B arranged at the center in the thickness direction, the side lobe can be reduced.

In a configuration in which Re of the retardation layer of the retardation layer set A arranged on both end sides in the thickness direction is larger and θs of the retardation layer set A is smaller, respectively, than those of the retardation layer set B arranged at the center in the thickness direction, the number of retardation layers constituting the retardation layer set A and the number of retardation layers constituting the retardation layer set B, that is, how to separate the retardation layer set A and the retardation layer set B from each other is not limited, and may be appropriately set depending on the number of retardation layers (retardation layer sets) included in the polarization interference element.

In addition, with regard to Re and θs of the retardation layer of the retardation layer set A and Re and θs of the retardation layer of the retardation layer set B, optimum Re and θs that allow the polarization interference element to act as a λ/2 retardation plate and to reduce side lobes may be set by simulation.

Furthermore, it is preferable that the change in θs of the retardation layer set and the change in Re of the retardation layer of the retardation layer set from both end sides in the laminated direction (thickness direction) toward the center are controlled as gently and finely as possible.

A thickness d of the first retardation layer 32 and the second retardation layer 34 is not limited, and the thickness d at which Re is the half-wavelength of a central wavelength in the wavelength range transmitted through the filter 10 may be appropriately set depending on the constituent materials of the first retardation layer 32 and the second retardation layer 34, and the like.

The thickness d of the first retardation layer 32 and the second retardation layer 34 is preferably 5 to 100 μm, and more preferably 10 to 80 μm.

The thickness d of the first retardation layer and the thickness d of the second retardation layer constituting the same retardation layer set may be the same as or different from each other, but it is preferable that the thickness d is the same from the viewpoint of more easily designing optical characteristics.

The total number N of laminations of the first retardation layers 32 and the second retardation layers 34 is not limited as long as it is 4 or more and an even number in order to provide two or more retardation layer sets 30.

The total number N of laminations of the first retardation layers 32 and the second retardation layers 34 is preferably 4 to 30, more preferably 6 to 20, still more preferably 6 to 12, and particularly preferably 6 to 10.

In the polarization interference element 20, as the total number N of laminations of the first retardation layers 32 and the second retardation layers 34 is larger, that is, as the number of the retardation layer sets 30 is larger, the wavelength range in which the polarization interference element 20 acts as a λ/2 retardation layer is narrower.

Accordingly, in the polarization interference element of the embodiment of the present invention, as the total number N of laminations of the first retardation layers and the second retardation layers is larger, the half-width of the wavelength range of transmitted light is narrower. In other words, as the total number N of laminations of the first retardation layers and the second retardation layers is larger, a band-pass filter having a narrower transmission wavelength range can be manufactured by arranging the polarization interference element between the two polarizers arranged in a crossed nicols state.

In the polarization interference element of the embodiment of the present invention, the total number N of laminations of the first retardation layers and the second retardation layers, that is, the number of the retardation layer sets, may be appropriately selected depending on the width of the transmission wavelength range required for the polarization interference element. In case where a broad range is preferable, a small number of layers may be selected, and in a case where a narrow range is required, a large number of layers may be selected.

As the retardation layer included in the polarization interference element of the embodiment of the present invention, a known retardation film in which each of the Nz factor and Re is the predetermined value can be appropriately used. Such a retardation film can be obtained by controlling the refractive index in the thickness direction, for example, by a method of biaxially stretching a high-molecular-weight polymer film in a plane direction, or a method of uniaxially or biaxially stretching a polymer film in a plane direction and stretching the polymer film in the thickness direction. In addition, the retardation film is obtained by a method of adhering a heat shrinkable film to a high-molecular-weight polymer film and performing a stretching treatment and/or a shrinking treatment under the action of a shrinking force by heating to tilt-align the polymer film.

In addition, the retardation film may be an alignment film of a liquid crystal polymer or an alignment film of a low-molecular-weight liquid crystal.

Examples of a high-molecular-weight polymer constituting the high-molecular-weight polymer film include cellulose-based polymers such as cellulose acylate, hydroxyethyl cellulose, hydroxypropyl cellulose, and methyl cellulose; acrylic polymers such as polymethyl methacrylate; styrene-based polymers such as polystyrene and an acrylonitrile-styrene copolymer (AS resin); polyolefins such as a polycarbonate and polypropylene; polyesters such as polyethylene terephthalate and polyethylene naphthalate; alicyclic polyolefins such as polynorbornene; and polyvinyl alcohol, polyvinyl butyral, polymethyl vinyl ether, polyhydroxyethyl acrylate, polyarylate, polysulfone, polyether sulfone, polyphenylene sulfide, polyphenylene oxide, polyaryl sulfone, polyvinyl alcohol, polyamide, polyimide, and polyvinyl chloride; as well as various binary and ternary copolymers, graft copolymers, and blends thereof.

Among these, the retardation layer is preferably the cellulose-based polymer film, and more preferably the cellulose acylate film.

In a case where the cellulose acylate film is used as the retardation layer included in the polarization interference element, the Nz factor, Re, and the direction of the in-plane slow axis can be adjusted by a stretching ratio at a time of stretching the cellulose acylate film in the transport direction and/or the width direction, a ratio at a time of stretching or shrinking the cellulose acylate film in the thickness direction, a total degree of substitution of the cellulose acylate constituting the cellulose acylate film, a distribution of degrees of substitution at the 2-position, the 3-position, and the 6-position, or the like.

In addition, with regard to the retardation film that can be used as the retardation layer included in the polarization interference element of the embodiment of the present invention, reference can be made to the description in JP2009-235374A, the content of which is incorporated herein by reference.

The polarization interference element may have a layer other than the first retardation layer and the second retardation layer constituting the retardation layer set.

Examples of the other layer include a pressure sensitive adhesive layer used for manufacturing a polarization interference element which will be described later. It is preferable that the polarization interference element does not have a layer other than the first retardation layer and the second retardation layer constituting the retardation layer set and the pressure sensitive adhesive layer.

### Method for Manufacturing Polarization Interference Element

A method for manufacturing a polarization interference element of an embodiment of the present invention is not particularly limited as long as it is a method capable of manufacturing a polarization interference element having two or more specific retardation layer sets in a thickness direction, and the polarization interference element can be manufactured by a known method.

The polarization interference element of the embodiment of the present invention can be manufactured, for example, by manufacturing or preparing a retardation film having predetermined values of an Nz factor and Re, and then laminating the retardation film using a transparent adhesive with respect to transmitted light.

A more specific example of the method for manufacturing a polarization interference element is as follows.

First, a pressure sensitive adhesive layer is formed on a surface of a retardation film prepared as the first retardation layer using a pressure sensitive adhesive. Subsequently, another retardation film is laminated on the surface of the formed pressure sensitive adhesive layer to form a first retardation layer set. In this case, the arrangement of the second retardation layer to be laminated is adjusted such that the in-plane slow axis of the first retardation layer and the in-plane slow axis of the second retardation layer intersect with each other.

Next, a pressure sensitive adhesive layer is formed on the surface of the second retardation layer of the first retardation layer set, and an additional retardation film (first retardation layer) is laminated on the surface of the formed pressure sensitive adhesive layer. In a case where the additional retardation film is laminated, the direction of the in-plane slow axis of the first retardation layer or the second retardation layer of the first retardation layer set and the direction of the in-plane slow axis of the first retardation layer of the second retardation layer set are adjusted, as necessary. Further, a pressure sensitive adhesive layer is formed on the surface of the laminated first retardation layer, and an additional retardation film (second retardation layer) is laminated on the surface of the formed pressure sensitive adhesive layer while adjusting the in-plane slow axis to be directed in a specific direction, thereby forming a second set of retardation layer set.

The polarization interference element of the embodiment of the present invention is manufactured by repeating the treatment for laminating the retardation film as described above the number of times corresponding to the target number of retardation layers, that is, the number of retardation layers to be formed.

As the pressure sensitive adhesive layer, a layer consisting of a known material can be used as long as the layer has a function of bonding two target retardation films or a retardation film and a polarizer. Examples of the pressure sensitive adhesive layer include a layer consisting of a known pressure sensitive adhesive used in an optical system, such as an optical clear adhesive (OCA) and an acrylic pressure sensitive adhesive.

In the polarization interference element, the thickness of the pressure sensitive adhesive layer provided between the first retardation layer and the second retardation layer is, for example, 5 to 100 μm, and preferably 5 to 40 μm.

The method for manufacturing a polarization interference element is not limited to the method in which the retardation layers are repeatedly laminated by bonding the retardation films individually manufactured using a pressure sensitive adhesive. For example, the polarization interference element of the embodiment of the present invention can also be manufactured by repeatedly performing a treatment for directly forming another retardation layer on a surface of a base material or a retardation layer.

As described above, the polarization interference element of the embodiment of the present invention is useful for manufacturing a band-pass filter. In particular, by using the polarization interference element of the embodiment of the present invention while being arranged between two polarizers, a band-pass filter in which a shift in wavelength at which the maximum transmittance is exhibited is unlikely to occur even in a case where light is incident from an oblique direction can be manufactured.

In addition, the polarization interference element of the embodiment of the present invention can be used alone, and can be used, for example, as a λ/2 retardation plate that acts only on light in a specific wavelength range.

### Filter

The filter of the embodiment of the present invention has the above-described polarization interference element of the embodiment of the present invention and two polarizers that sandwich the polarization interference element in the thickness direction.

An example of the configuration of the filter of the embodiment of the present invention will be described again with reference to FIG. 1. The filter 10 shown in FIG. 1 is a filter including a polarization interference element 20 and two polarizers (the first polarizer 12 and the second polarizer 14) that sandwich the polarization interference element 20 in the thickness direction, in which the two polarizers are arranged in a crossed nicols state where transmission axes of the two polarizers are orthogonal to each other.

In the filter 10 shown in FIG. 1, the first polarizer 12 and the polarization interference element 20 are spaced from each other, and the second polarizer 14 and the polarization interference element 20 are spaced from each other.

The filter of the embodiment of the present invention is not limited to the aspect shown in FIG. 1, and for example, at least one of the first polarizer or the second polarizer may be laminated in direct contact with the polarization interference element.

In addition, the filter of the embodiment of the present invention may further have a pressure sensitive adhesive layer between the polarization interference element and the first polarizer, and/or between the polarization interference element and the second polarizer. That is, the polarization interference element and the first polarizer or the second polarizer may be bonded to each other with a pressure sensitive adhesive that is transparent to transmitted light. Examples of the pressure sensitive adhesive include known pressure sensitive adhesives such as the above-described OCA and acrylic pressure sensitive adhesive.

The two polarizers included in the filter of the embodiment of the present invention are polarizers (polarizing plates) that transmit linearly polarized light in a predetermined direction. In the filter 10 shown in FIG. 1, in a case where two polarizers are viewed from the thickness direction, the two polarizers are arranged in a crossed nicols state where transmission axes thereof are orthogonal to each other.

The type of the polarizer used in the filter is not particularly limited, and various known linear polarizers such as an iodine-based polarizer, a dye-based polarizer using a dichroic dye, a polyene-based polarizer, and a wire grid polarizer can be used.

In a case where the two polarizers included in the filter of the embodiment of the present invention are arranged in a crossed nicols state, it is preferable that in a case where the filter is viewed in the thickness direction, the direction of a transmission axis of either of the two polarizers and the direction of a bisector Lb of an angle θs formed between the in-plane slow axis of a first retardation layer and the in-plane slow axis of a second retardation layer constituting one retardation layer included in the polarization interference element are the same as each other. Specifically, it is preferable that the angle formed between a transmission axis of either of the two polarizers and a bisector Lb of one retardation layer set (more preferably, a bisector Lb of all retardation layer sets) is within 10°, and it is more preferable that the transmission axis and the bisector Lb coincide (the angle is 0°).

The filter of the embodiment of the present invention may further have a third retardation layer between at least one of the two polarizers and the polarization interference element.

The third retardation layer is a retardation layer different from the first retardation layer and the second retardation layer included in the polarization interference element, and an in-plane slow axis of the third retardation layer is parallel to an absorption axis of either of the two polarizers.

Specific examples of the filter further having a third retardation layer include a filter having a first polarizer, a third retardation layer, the polarized interference element of the embodiment of the present invention, and a second polarizer in this order, in which the first polarizer and the second polarizer are arranged in a crossed nicols state, and the in-plane slow axis of the third retardation layer is parallel to the absorption axis of the adjacent first polarizer.

In the specific example, the third retardation layer brings about an effect of maintaining the orthogonal relationship of the polarization directions by the linear polarizers (the first polarizer and the second polarizer) arranged in a crossed nicols state even in an oblique direction (off-axis) deviated from the front. This makes it possible to obtain good band-pass characteristics that are the same as those in the front even in the oblique direction. In other words, by making the in-plane slow axis of the third retardation layer parallel to an absorption axis of either of the two polarizers arranged in a crossed nicols state, the polarization state can be compensated to maintain the orthogonal relationship of the direction in the oblique direction while not influencing the polarized light in the front.

As the third retardation layer, a known retardation film can be appropriately used, and a positive C-plate formed by vertical alignment of rod-like liquid crystals and a positive A-plate formed by horizontal alignment of rod-like liquid crystals; a negative C-plate formed by disk-like liquid crystals, a negative A-plate formed by disk-like liquid crystals; or a combination thereof can be used. In addition, a B-plate (preferably a B-plate having an Nz factor of 0.1 to 0.9) that is a biaxial refractive index body can also be used.

Moreover, as the third retardation layer, each of the retardation films exemplified as specific examples of the retardation layer included in the polarization interference element of the embodiment of the present invention can also be used.

In addition, in the filter 10 shown in FIG. 1, the two polarizers are arranged in a crossed nicols state, but in the filter of the embodiment of the present invention, the arrangement relationship between the two polarizers may be other than the crossed nicols state. For example, the two polarizers may be arranged in a parallel nicols state where transmission axes of the two polarizers are parallel to each other in a case where the two polarizers are viewed in the thickness direction.

In a case where the two polarizers included in the filter of the embodiment of the present invention are arranged in a parallel nicols state, the appropriate values of Re and the in-plane slow axis direction of each retardation layer included in the polarization interference element can be appropriately set by simulation, for example, depending on the central wavelength of the wavelength range of light transmitted through the filter, the number N of laminations of the retardation layers, and the like.

### Method for Manufacturing Filter

The method for manufacturing a filter of an embodiment of the present invention is not particularly limited. For example, the filter of the embodiment of the present invention can be manufactured by bonding two polarizers to the surfaces of both end sides of the polarization interference element of the embodiment of the present invention in the thickness direction using a pressure sensitive adhesive.

In this case, for example, the position of the polarizer to be bonded to the polarization interference element is adjusted such that the two polarizers are arranged in a crossed nicols state or a parallel nicols state.

The transmission axis of the polarizer of the filter of the embodiment of the present invention is set to an appropriate angle in order to preferably obtain desired band-pass characteristics. In particular, by setting the transmission axis of the polarizer at an appropriate angle, the size of side lobes generated in wavelength ranges (the longer wavelength side and the shorter wavelength side) on both sides of the main band-pass wavelength can be reduced, and the sizes of side lobes on the longer wavelength side and the shorter wavelength side can be made uniform.

Such a filter of the embodiment of the present invention can be used at any wavelength. That is, the filter of the embodiment of the present invention can be used for any electromagnetic waves such as ultraviolet rays, visible light, infrared rays, terahertz waves, and millimeter waves.

Hereinbefore, the polarization interference element and the filter of the embodiments of the present invention have been described in detail. However, the present invention is not limited to the above-described examples, and various improvements and modifications may be made without departing from the scope of the present invention.

### EXAMPLES

Hereinafter, the characteristics of the present invention will be described in detail with reference to Examples. The materials, the reagents, the amounts, the amounts of materials, the proportions, the treatment details, the treatment procedures, and the like shown in Examples below can be appropriately modified within a range not departing from the spirit of the present invention. Therefore, the scope of the present invention should not be construed as being limited to specific examples shown below.

### Example 1

### Preparation of Cellulose Acylate Solution

The following composition was put into a mixing tank, stirred to dissolve each component, further heated at 90° C. for about 10 minutes, and then filtered through a filter paper having an average pore diameter of 34 μm and a sintered metal filter having an average pore diameter of 10 μm, thereby preparing a cellulose acylate solution (dope).

### Cellulose Acylate Solution

| | |
|---|---|
| Cellulose acylate (degree of substitution - | 100.0 parts by mass |
| benzoyl group: 0.86, acetyl group: 1.76) | |
| Dichloromethane | 462.0 parts by mass |

### Manufacture of Retardation Film

The prepared dope was cast using a metal band casting machine and the dope was dried to form a film. Thereafter, the formed film was peeled off from the band by a peeling drum to manufacture an unstretched cellulose acylate film.

Next, the manufactured unstretched film was introduced into a zone of a tenter-type stretching device set to a temperature of (glass transition point Tg of film−stretching temperature)=−5° C., and uniaxially stretched at a fixed end by 10% in the film transport direction (MD). Next, in the zone set to the same temperature, the film was uniaxially stretched at a fixed end by 65% in the width direction (TD). By performing the biaxial stretching treatment in this manner, a retardation film 1 consisting of a biaxially stretched cellulose acylate film was manufactured. Furthermore, the film thickness of the dope was adjusted so that the film thickness of the retardation film 1 after biaxial stretching and drying was 30 μm.

The in-plane retardation Re, the in-plane slow axis angle θ, and the Nz factor of the retardation film 1 were measured using AxoScan (manufactured by Axometrics, Inc.). As a result, the retardation film 1 had Re of 275 nm and an Nz factor of 0.5.

### Manufacture of Polarization Interference Element

Next, the manufactured eight retardation films 1 were sequentially laminated using a pressure sensitive adhesive (“SK Dyne 2057” manufactured by Soken Chemical & Engineering Co., Ltd.). In a case where each retardation film 1 was laminated, the arrangement of the retardation film 1 to be bonded was adjusted such that the azimuthal angle θ of the in-plane slow axis of each retardation layer as viewed from the viewing side was an angle shown in Table 1 below and the azimuthal angle of the bisector Lb of the angle θs of the retardation layer set coincided.

In this manner, a polarization interference element including four retardation layer sets, each consisting of the first retardation layer and the second retardation layer in the thickness direction, was manufactured.

Furthermore, in the present Example, the angle θ (°) of the in-plane slow axis of the retardation layer in the polarization interference element is an angle at which a bisector Lb of an angle θs between the in-plane slow axis of the first retardation layer and the in-plane slow axis of the second retardation layer is 0°, the in-plane clockwise is defined as positive (+) and the in-plane counterclockwise is defined as negative (−). In addition, the azimuthal angles of the bisectors Lb of angles θs's of the four retardation layer sets included in the polarization interference element coincide.

TABLE 1

| | Re | | In-plane slow axis | Retardation |
|---|---|---|---|---|
| N | (nm) | Nz | θ (°) | layer set |
| 1 | 275 | 0.5 | 5.6 | 1 |
| 2 | 275 | 0.5 | −5.6 | |
| 3 | 275 | 0.5 | 5.6 | 2 |
| 4 | 275 | 0.5 | −5.6 | |
| 5 | 275 | 0.5 | 5.6 | 3 |
| 6 | 275 | 0.5 | −5.6 | |
| 7 | 275 | 0.5 | 5.6 | 4 |
| 8 | 275 | 0.5 | −5.6 | |

### Manufacture of Band-Pass Filter

Two linear polarizers having a configuration in which transparent protective films were bonded to both front and rear surfaces of a polyvinyl alcohol film on which iodine was adsorbed and aligned were prepared. The prepared two linear polarizers were bonded to both end sides of the polarization interference element manufactured above in the thickness direction, thereby obtaining a band-pass filter having a layer configuration as shown in FIG. 1.

In a case where the linear polarizers were bonded, the transmission axis of one linear polarizer was parallel to the bisector Lb of the angle θs formed between the in-plane slow axis of the first retardation layer and the in-plane slow axis of the second retardation layer, included in the polarization interference element, and the two linear polarizers were arranged to be in a crossed nicols state.

### Example 2

A retardation film 2 having an in-plane retardation Re of 275 nm and an Nz factor of 0.3 was manufactured in the same manner as in Example 1, except that in the step of manufacturing the retardation film 1 of Example 1, the stretching ratio of the unstretched film in each of the MD and TD directions was adjusted. A polarization interference element was manufactured using the same method as in Example 1, except that the retardation film 2 was used instead of the retardation film 1, and a band-pass filter was manufactured using the obtained polarization interference element.

### Example 3

A retardation film 3 having an in-plane retardation Re of 275 nm and an Nz factor of 0.7 was manufactured in the same manner as in Example 1, except that in the step of manufacturing the retardation film 1 of Example 1, the stretching ratio of the unstretched film in each of the MD and TD directions was adjusted. A polarization interference element was manufactured using the same method as in Example 1, except that the retardation film 3 was used instead of the retardation film 1, and a band-pass filter was manufactured using the obtained polarization interference element.

### Example 4

A retardation film 3a having an in-plane-direction retardation Re of 291 nm and an Nz factor of 0.5 and a retardation film 3b having an in-plane-direction retardation Re of 267 nm and an Nz factor of 0.5 were each manufactured in the same manner as in Example 1, except that in the step of manufacturing the retardation film 1 of Example 1, the stretching ratio of the unstretched film in each of the MD and TD directions was adjusted.

Next, the manufactured four retardation films 3a and four retardation films 3b were laminated in the order shown in Table 2 below using a pressure sensitive adhesive (“SK Dyne 2057” manufactured by Soken Chemical & Engineering Co., Ltd.). In a case where each of the retardation films was laminated, the arrangement of the retardation film 3a or 3b to be bonded was adjusted such that the in-plane slow axis of each of the retardation layers was an angle shown in Table 2 below as viewed from the viewing side.

In this manner, a polarization interference element including four retardation layer sets, each consisting of the first retardation layer and the second retardation layer in the thickness direction, was manufactured.

TABLE 2

| | Re | | In-plane slow axis | Retardation | Retardation |
|---|---|---|---|---|---|
| N | (nm) | Nz | θ (°) | film | layer set |
| 1 | 291 | 0.5 | 1.8 | 3a | 1 |
| 2 | 291 | 0.5 | −1.8 | 3a | |
| 3 | 267 | 0.5 | 9.4 | 3b | 2 |
| 4 | 267 | 0.5 | −9.4 | 3b | |
| 5 | 267 | 0.5 | 9.4 | 3b | 3 |
| 6 | 267 | 0.5 | −9.4 | 3b | |
| 7 | 291 | 0.5 | 1.8 | 3a | 4 |
| 8 | 291 | 0.5 | −1.8 | 3a | |

### Comparative Example 1

### Formation of Alignment Film

A glass substrate was prepared as a support. The following coating liquid for forming an alignment film was applied onto the support by spin coating. The support on which the coating film of the coating liquid for forming an alignment film was formed was dried for 60 seconds on a hot plate at 60° C. to form an alignment film P-1.

### Coating Liquid for Forming Alignment Film

| | | |
|---|---|---|
| Material for photo alignment below | 1.00 | part by mass |
| Water | 16.00 | parts by mass |
| Butoxyethanol | 42.00 | parts by mass |
| Propylene glycol monomethyl ether | 42.00 | parts by mass |

Material for photo alignment

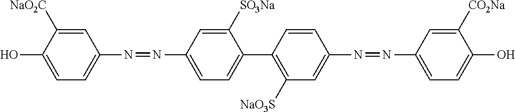

### Exposure of Alignment Film

Next, the alignment film P-1 was irradiated with linearly polarized light using an ultraviolet exposure device and a wire grid polarizer (manufactured by Moxtek, Inc., ProFlux PPL02) installed so that the angle of the absorption axis was Φ1 (=) 0°, and thus, the alignment film P-2 was obtained. For the ultraviolet rays, the illuminance was set to 4.5 mW/cm2 and the integrated irradiation amount was set to 300 mJ/cm².

Furthermore, the angle of the absorption axis is an angle with respect to the longitudinal direction of the substrate, and clockwise is defined as positive.

### Formation of Horizontally Aligned Liquid Crystal Layer Using Rod-Like Liquid Crystal Compound

As a liquid crystal composition forming a horizontally aligned liquid crystal layer, the following composition B-1 was prepared.

### Composition B-1

| | | |
|---|---|---|
| Rod-like liquid crystal compound L-1 below | 100.00 | parts by mass |
| Polymerization initiator (Irgacure (registered trade name) 907, manufactured by BASF SE) | 3.00 | parts by mass |
| Photosensitizer (KAYACURE DETX-S, manufactured by Nippon Kayaku Co., Ltd.) | 1.00 | part by mass |
| Leveling agent T-1 below | 0.08 | parts by mass |
| Methyl ethyl ketone | 2,000.00 | parts by mass |

Rod-like liquid crystal compound L-1 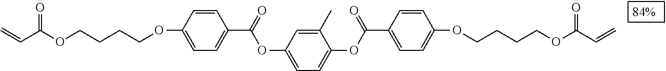 [SMILES: C=CC(=O)OCCCCOc1ccc(C(=O)Oc2ccc(OC(=O)c3ccc(OCCCCOC(=O)C=C)cc3)c(C)c2)cc1] 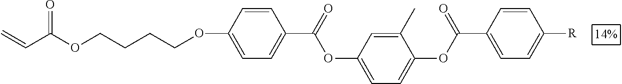 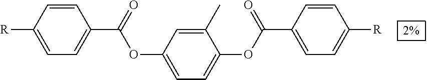 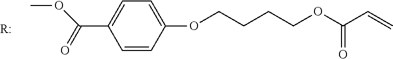
Leveling agent T-1

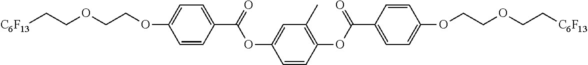

The horizontally aligned liquid crystal layer was formed by applying the composition B-1 onto the alignment film P-2. That is, first, the composition B-1 was applied onto the alignment film P-2, and the film was heated and then cured with ultraviolet rays to manufacture a liquid crystal immobilized layer.

To describe in more details, the liquid crystal immobilized layer was manufactured by applying the composition B-1 to the alignment film P-2 to obtain a coating film, the coating film was heated on a hot plate at 80° C., and then the coating film was irradiated with ultraviolet rays having a wavelength of 365 nm at an irradiation dose of 300 mJ/cm² using a high-pressure mercury lamp under a nitrogen atmosphere at 80° C. to immobilize the alignment of the liquid crystal compound. The thickness of the horizontally aligned liquid crystal layer after the immobilization was 1.72 μm.

After forming the horizontally aligned liquid crystal layer by the above-described method, the horizontally aligned liquid crystal layer was peeled off from the photo alignment film. The formed horizontally aligned liquid crystal layer was confirmed to have the characteristics shown in Table 1 using AxoScan (manufactured by Axometrics, Inc.). Furthermore, in Table 1, Re represents an in-plane retardation.

Eight such horizontally aligned liquid crystal layers were manufactured.

TABLE 3

| Thickness d | Birefringence | Re |
|---|---|---|
| (μm) | Δn | (nm) |
| 1.72 | 0.16 | 275 |

Using the one horizontally aligned liquid crystal layer manufactured as described above as the first liquid crystal layer and the second liquid crystal layer, the two horizontally aligned liquid crystal layers were bonded using a pressure sensitive adhesive (SK Dyne 2057, manufactured by Soken Chemical & Engineering Co., Ltd.) such that the angle formed between the in-plane slow axes was 11.25°, that is, the angles with respect to the bisector of the angle formed between the in-plane slow axes were +5.625° and −5.625°, respectively, to manufacture a liquid crystal layer set. Four liquid crystal layer sets were formed in the same manner.

A liquid crystal polarization interference element of Comparative Example 1 was manufactured by bonding the four liquid crystal layer sets using a pressure sensitive adhesive (SK Dyne 2057, manufactured by Soken Chemical & Engineering Co., Ltd.). In this case, the liquid crystal layers were laminated such that the bisectors of angles formed between the in-plane slow axes in each liquid crystal layer set were parallel to each other.

A band-pass filter was manufactured by the same method as in Example 1, except that the liquid crystal polarization interference element of Comparative Example 1 was used instead of the polarization interference element. In this case, the liquid crystal layers were laminated such that the transmission axis of one linear polarizer and the bisector of an angle formed between the in-plane slow axes in each liquid crystal layer set were parallel to each other.

### Evaluation

With regard to the band-pass filters manufactured in Examples 1 to 4 and Comparative Example 1, in a case where light was incident from the thickness direction (direction of polar angle of 90°) of the band-pass filter, the central wavelength (unit: nm), the half-width (unit: nm), and the side lobe value of the transmitted light were measured using a spectral radiometer “SR-3” manufactured by Topcon Technohouse Corporation. The side lobe value is a proportion of the transmittance of the side lobe to the transmittance of the central wavelength of the transmitted light.

Further, the central wavelength (unit: nm) of transmitted light in a case where light was incident from an oblique direction (polar angle of 60°) was measured, and the absolute value of a difference between the central wavelength in a case where light was incident from the polar angle of 60° and the central wavelength in a case where light was incident from the direction of a polar angle of 90° was calculated as the wavelength shift. Furthermore, the light from a polar angle of 60° was incident from directions of azimuth angles of 0°, 45°, 90°, and 135°, and an average value thereof was regarded as a measured value.

The characteristics of the band-pass filters of Examples 1 to 4 and Comparative Example 1 and the measurement results are shown in Table 4.

In the column of “Requirement A” in the table, the notation of “1” means that the band-pass filter satisfies the requirement A, and the notation of “2” means that the band-pass filter does not satisfy the requirement A.

The notation of “≤3” in the column of “Side lobe value (%)” in the table means that the side lobe value was 3% or less.

TABLE 4

| | | | Central | | Wavelength | Side lobe |
|---|---|---|---|---|---|---|
| | | Requirement | wavelength | Half-width | shift | value |
| | Nz | A | (nm) | (nm) | (nm) | (%) |
| Example 1 | 0.5 | 2 | 550 | 120 | 4 | 10 |
| Example 2 | 0.3 | 2 | 550 | 120 | 15 | 10 |
| Example 3 | 0.7 | 2 | 550 | 120 | 15 | 10 |
| Example 4 | 0.5 | 1 | 550 | 120 | 4 | ≤3 |
| Comparative | 1.0 | 2 | 550 | 120 | 80 | 10 |
| Example 1 | | | | | | |

As a result, the wavelength shift of the central wavelength of the transmitted light in the band-pass filter of Comparative Example 1 was 80 nm, whereas the wavelength shift of the central wavelength of the transmitted light in the band-pass filters of Examples 1 to 4 was 15 nm or less.

As described above, it was confirmed that the polarization interference element of the embodiment of the present invention is a polarization interference element in which a shift in wavelength at which the maximum transmittance is exhibited is unlikely to occur even in a case where light is incident from an oblique direction during use of the polarization interference element arranged between two polarizers arranged in a crossed nicols state.

Furthermore, from the comparison between Examples 1 to 3 and Example 4, it was confirmed that in a case where the polarization interference element has three or more retardation layer sets in a thickness direction, and the retardation layer sets A arranged at both ends in the thickness direction and the retardation layer set B arranged between the retardation layer sets A satisfy the requirement A, that is, in a case where the angle formed between the in-plane slow axis of the first retardation layer and the in-plane slow axis of the second retardation layer in the retardation layer set A is smaller than the angle formed between the in-plane slow axis of the first retardation layer and the in-plane slow axis of the second retardation layer in the retardation layer set B, and Re of the first retardation layer (=Re of the second retardation layer) in the retardation layer set A is larger than Re of the first retardation layer (=Re of the second retardation layer) in the retardation layer set B, the side lobe value of the band-pass filter can be reduced.

### Example 5

A polarization interference element including six retardation layer sets, each consisting of a first retardation layer and a second retardation layer in the thickness direction, was manufactured in accordance with the method for manufacturing the polarization interference element described in Example 1, except that twelve retardation films 1 were sequentially laminated and the arrangement of the retardation films 1 to be bonded during lamination of each of the retardation films 1 was adjusted such that the azimuthal angle θ of the in-plane slow axis of each retardation layer as viewed from the viewing side was the angle shown in Table 5 below, and the azimuthal angles of the bisector lines Lb of the angles θs's of the retardation layer sets coincided.

Next, a band-pass filter was manufactured according to the manufacture method described in Example 1, except that the polarization interference element manufactured above was used.

TABLE 5

| | Re | | In-plane slow axis | Retardation |
|---|---|---|---|---|
| N | (nm) | Nz | θ (°) | layer set |
| 1 | 275 | 0.5 | 3.75 | 1 |
| 2 | 275 | 0.5 | −3.75 | |
| 3 | 275 | 0.5 | 3.75 | 2 |
| 4 | 275 | 0.5 | −3.75 | |
| 5 | 275 | 0.5 | 3.75 | 3 |
| 6 | 275 | 0.5 | −3.75 | |
| 7 | 275 | 0.5 | 3.75 | 4 |
| 8 | 275 | 0.5 | −3.75 | |
| 9 | 275 | 0.5 | 3.75 | 5 |
| 10 | 275 | 0.5 | −3.75 | |
| 11 | 275 | 0.5 | 3.75 | 6 |
| 12 | 275 | 0.5 | −3.75 | |

The performance of the band-pass filter of Example 5 was evaluated according to the method described in [Evaluation] above. The results are shown in the following table.

TABLE 6

| | Central | | | |
|---|---|---|---|---|
| | wavelength | Half-width | Wavelength | Side lobe |
| | (nm) | (nm) | shift (nm) | value (%) |
| Example 5 | 550 | 80 | 4 | 10 |

From the results above, it was also confirmed that the polarization interference element of Example 5 can suppress the wavelength shift in a case where light was incident from an oblique direction during use of the polarization interference element arranged between the two polarizers arranged in a crossed nicols state.

### Example 6

A polarization interference element was manufactured in the same manner as in Example 1, and two linear polarizers were prepared. In addition, a retardation film 1 manufactured in Example 1 was prepared separately from the retardation film used in the manufacture of the polarization interference element. A band-pass filter was manufactured in accordance with the step of manufacturing the band-pass filter of Example 1, except that each member was bonded such that the retardation film 1 was arranged between one linear polarizer of the two linear polarizers arranged in a crossed nicols state and the polarization interference element.

In the obtained band-pass filter of Example 6, one linear polarizer, the third retardation layer, the polarization interference element, and the other linear polarizer were arranged in this order. In addition, the third retardation layer adjacent to the one linear polarizer had Re of 275 nm and an Nz factor of 0.5, and the in-plane slow axis of the third retardation layer was parallel to the absorption axis of the one linear polarizer.

The performance of the band-pass filter of Example 6 was evaluated according to the method described in [Evaluation] above. The results are shown in the following table.

TABLE 7

| | Central | | | |
|---|---|---|---|---|
| | wavelength | Half-width | Wavelength | Side lobe |
| | (nm) | (nm) | shift (nm) | value (%) |
| Example 5 | 550 | 120 | 3 | 10 |

From the results above, it was confirmed that the filter of Example 6 can further suppress the wavelength shift in a case where light was incident from an oblique direction, as compared with the filters of Examples 1 to 5.

That is, it was confirmed that the effect of maintaining the orthogonal relationship between the polarization directions of the two linear polarizers in both of a case where light is incident from the front and a case where light is incident from an oblique direction is achieved by arranging a third retardation layer between at least one of the two linear polarizers arranged in a crossed nicols state and the polarization interference element.

### Example 7

A polarization interference element was manufactured according to the method described in Example 1, except that the arrangement of the retardation films 1 to be bonded was adjusted such that the azimuthal angle θ of the in-plane slow axis of each retardation layer as viewed from the viewing side was the angle shown in Table 8 below during lamination of eight retardation films 1 in Example 1.

Next, a band-pass filter was manufactured by bonding two linear polarizers to both end sides of the polarization interference element in the thickness direction according to the method for manufacturing the band-pass filter described in Example 1, except that the polarization interference element manufactured above was used and the two linear polarizers were arranged to be in a parallel nicols state where the transmission axes of the two linear polarizers were parallel to each other.

Each retardation layer of the polarization interference element manufactured in Example 7 corresponds to a plurality of birefringent plates (λ/2 retardation plates) having the same thickness and angles of ρ, 3ρ, 5ρ, . . . with respect to the transmission axis of the linear polarizer as viewed from the thickness direction, and the band-pass filter of Example 7 corresponds to a Solc filter (fan Solc filter) in which the plurality of birefringent plates are laminated between the polarizers arranged in the parallel nicols state.

TABLE 8

| | Re | | In-plane slow axis |
|---|---|---|---|
| N | (nm) | Nz | θ (°) |
| 1 | 275 | 0.5 | 5.625 |
| 2 | 275 | 0.5 | 16.875 |
| 3 | 275 | 0.5 | 28.125 |
| 4 | 275 | 0.5 | 39.375 |
| 5 | 275 | 0.5 | 50.625 |
| 6 | 275 | 0.5 | 61.875 |
| 7 | 275 | 0.5 | 73.125 |
| 8 | 275 | 0.5 | 84.375 |

The performance of the band-pass filter of Example 7 was evaluated according to the method described in [Evaluation] above. The results are shown in the following table.

TABLE 9

| | Central | | Wavelength | |
|---|---|---|---|---|
| | wavelength | Half-width | shift | Side lobe |
| | (nm) | (nm) | (nm) | value (%) |
| Example 7 | 550 | 80 | 4 | 10 |

From the results above, it was confirmed that the polarization interference element of the embodiment of the present invention can suppress a wavelength shift in a case where light is incident from an oblique direction even during use of the polarization interference element arranged between two polarizers arranged in parallel.

The polarization interference element and the filter of the embodiments of the present invention can be suitably used as an optical filter such as a band-pass filter included in various optical devices.

### EXPLANATION OF REFERENCES

10: filter
12: first polarizer

114: second polarizer
20: polarization interference element
30: retardation layer set
32: first retardation layer
34: second retardation layer

What is claimed is:

1. A polarization interference element comprising:
two or more retardation layer sets in a thickness direction, each set consisting of a first retardation layer and a second retardation layer,
wherein an Nz factor of the first retardation layer and an Nz factor of the second retardation layer are each independently 0.3 to 0.7,
an in-plane slow axis of the first retardation layer and an in-plane slow axis of the second retardation layer intersect with each other, and
an in-plane retardation of the first retardation layer and an in-plane retardation of the second retardation layer are equal to each other.

2. The polarization interference element according to claim 1,
wherein the polarization interference element has three or more retardation layer sets in the thickness direction, and
two retardation layer sets A arranged at both ends in the thickness direction among the three or more retardation layer sets, and at least one retardation layer set B arranged between the retardation layer sets A among the three or more retardation layer sets satisfy the following requirement,
Requirement: an angle formed between an in-plane slow axis of the first retardation layer and an in-plane slow axis of the second retardation layer in the retardation layer set A is smaller than an angle formed between an in-plane slow axis of the first retardation layer and an in-plane slow axis of the second retardation layer in the retardation layer set B, and an in-plane retardation of the first retardation layer in the retardation layer set A is larger than an in-plane retardation of the first retardation layer in the retardation layer set B.

3. A filter comprising:
the polarization interference element according to claim 1; and
two polarizers that sandwich the polarization interference element in a thickness direction.

4. The filter according to claim 3,
wherein the two polarizers are arranged such that transmission axes of the two polarizers are orthogonal to each other.

5. The filter according to claim 3,
wherein the two polarizers are arranged such that transmission axes of the two polarizers are parallel to each other.

6. The filter according to claim 3, further comprising:
a third retardation layer between at least one of the two polarizers and the polarization interference element,
wherein an in-plane slow axis of the third retardation layer is parallel to an absorption axis of either of the two polarizers.

7. A filter comprising:
the polarization interference element according to claim 2; and
two polarizers that sandwich the polarization interference element in a thickness direction.

8. The filter according to claim 7,
wherein the two polarizers are arranged such that transmission axes of the two polarizers are orthogonal to each other.

9. The filter according to claim 7,
wherein the two polarizers are arranged such that transmission axes of the two polarizers are parallel to each other.

10. The filter according to claim 7, further comprising:
a third retardation layer between at least one of the two polarizers and the polarization interference element,
wherein an in-plane slow axis of the third retardation layer is parallel to an absorption axis of either of the two polarizers.

11. The filter according to claim 4, further comprising:
a third retardation layer between at least one of the two polarizers and the polarization interference element,
wherein an in-plane slow axis of the third retardation layer is parallel to an absorption axis of either of the two polarizers.

12. The filter according to claim 8, further comprising:
a third retardation layer between at least one of the two polarizers and the polarization interference element,
wherein an in-plane slow axis of the third retardation layer is parallel to an absorption axis of either of the two polarizers.

13. The filter according to claim 5, further comprising:
a third retardation layer between at least one of the two polarizers and the polarization interference element,
wherein an in-plane slow axis of the third retardation layer is parallel to an absorption axis of either of the two polarizers.

14. The filter according to claim 9, further comprising:
a third retardation layer between at least one of the two polarizers and the polarization interference element,
wherein an in-plane slow axis of the third retardation layer is parallel to an absorption axis of either of the two polarizers.
